(19) United States
(12) Patent Application Publication
(10) Pub. No.: US 2006/0093536 A1
(43) Pub. Date: May 4, 2006

(54) System and method for mixing a slurry

(76) Inventor: Daniel Ray Selby, Avondale, AZ (US)

Correspondence Address: GREENBERG TRAURIG LLP, 2450 COLORADO AVENUE, SUITE 400E, SANTA MONICA, CA, 90404, US

(21) Appl. No.: 10/979,458

(22) Filed: Nov. 2, 2004

(51) Int. Cl. B01J 8/00; B01J 19/00

(52) U.S. Cl. 422/234; 422/224; 422/225

(57) ABSTRACT

A system for mixing slurry includes a tank to contain the slurry during mixing and one or more scales supporting the tank so that the weight of materials added to the tank during mixing of the slurry can be measured. The system may further include a recirculating pipe coupled to recirculate at least some of the slurry removed from the tank by returning a recirculated slurry to an opening in the top of the tank. A feed pipe is positioned to provide fresh powder to the tank by mixing the powder into the recirculated slurry.

### BACKGROUND OF THE INVENTION

The present invention relates in general to a system and method for mixing dry particles with a liquid and, more specifically, to a system and method for preparing a slurry.

There are many chemical processes and other industrial applications which require mixing of dry solids with a liquid to obtain a working fluid or final slurry. To obtain satisfactory mixing of the solid and the liquid, the mixing device must typically meet two basic requirements. One requirement is that the device be capable of wetting the solids sufficiently to avoid forming agglomerates of the solid material. Secondly, the device must be able to furnish enough energy to thoroughly mix the solids and the liquid in a desired ratio in a final slurry.

One example of such a slurry is formed by mixing water and calcium oxide (CaO). Calcium-based compounds such as CaO and Ca(OH)₂ have many practical uses. For instance, these substances are used in treating waste water and sewage, soil neutralizing agents and nutrients, ground stabilization for construction, and components for building materials.

Calcium oxide is often referred to as “quicklime,” while Ca(OH)₂ is referred to as hydrated lime. Both CaO and Ca(OH)₂ are generally referred to as “lime”. Quicklime is usually in the form of lumps or pebbles. Dry, hydrated lime is usually in a finer powder form. In order to further process these compounds and improve the ease with which they are handled, dry CaO or Ca(OH)₂ is usually mixed with water to form a slurry. In the case of quicklime, the water reacts with the quicklime in an exothermic reaction to form hydrated lime. This is often referred to as slaking. During the slaking of quicklime, large amounts of heat are generated which can significantly raise the temperature of the slurry.

Lime slurries can be made in batches or in a continuous process. If a particular user requires a large amount of lime slurry at a particular site, large capacity slaking and storage tanks can be permanently located on the site. These tanks can usually provide a sufficient supply of lime and lime slurry for most operations. Often, however, it is not practical to provide permanent slaking or storage tanks for forming lime slurries. In the agricultural industry and in some construction industries, lime may be required only periodically or during certain seasons. Here, the limited use of lime may not justify the investment required for constructing and maintaining large capacity processing tanks and equipment. In other industries the location of the jobsites may change from day to day, such as in road construction, so that permanently located processing and storage tanks would be impractical. Here, lime slurries would have to be made at permanent lime processing facilities and then pumped into tanks to be hauled to the specific job locations.

Portable equipment, which can be moved from site to site, for forming lime slurries, is described by Teague et al. (U.S. Pat. No. 4,329,090), Scholl et al. (U.S. Pat. No. 6,412,974), and Shields et al. (U.S. Pat. No. 5,507,572), which patents are hereby incorporated by reference herein for their descriptions of systems and methods for mixing slurries and other teachings. Prior portable devices have several drawbacks, however. One major drawback to prior devices is that they are large and cumbersome, requiring several pieces of equipment that need to be hauled separately, thus requiring more manpower and expense to operate. In the Shields et al. device, there is no ready capacity of delivering the slurry made in the tank to tank trucks for spreading the hot lime slurry to a road surface. To achieve that function, it is necessary to take the hot lime slurry from the device and pump it to the delivery truck using a separate, additional piece of equipment. This equipment must be brought to the remote jobsite by a separate truck and thus requires additional expense, power source, and manpower. This limits the commercial applicability of the devices to larger sites and larger projects. Small projects and sites where space is limited, which are often the case, are thus impractical for use for these prior transportable lime slurry devices.

Some lime consumers do not purchase quicklime and slake it for their own consumption. Indeed, many cannot justify the cost of capital slaking equipment and the problems attendant to the processing steps that slaking entails. Their lime requirements are simply too small. Consequently, in order to make slaked lime more economical, an improved method of slaking and the apparatus used for slaking is highly desirable. What is desirable in particular is an easily transportable device that can expand the practical commercial use of lime slurries at remote sites. This would be an apparatus that is self-contained such that all the power sources and equipment necessary for the slurry operation are on one unit.

Although prior transportable systems for mixing slurries have been developed as mentioned above, such systems are typically designed for mixing and holding large volumes of slurry such as, for example, about 25,000 gallons. Such prior systems are slow at producing a final, mixed slurry, in part because of the large volume of slurry that needs to be prepared. This can result in slurry distribution or delivery trucks sitting idle at a jobsite while waiting for the slurry to be prepared.

For example, it may require one to three hours to load 20,000 gallons of water into a mixing tank, and then one to two hours to unload the mixed lime slurry. Such large tanks are typically used because the solid lime to be added must be weighed in a delivery truck at a weighing station, and then the entire truck load of, for example, about 25-27 tons of lime powder be added to the mixing tank in one large batch. In addition, the larger size of such prior tanks, which may be typically about 10 feet wide, requires obtaining special permits for moving from one site to another site over public roadways.

In light of the foregoing, there is a need for an improved system and method for preparing a mixed slurry at a jobsite that is more portable, can be used to make smaller loads, and in which such smaller load can be mixed faster than with prior slurry mixing systems.

### BRIEF DESCRIPTION OF THE DRAWING

For a more complete understanding of the present invention, reference is now made to the sole drawing, wherein like reference numbers refer to similar items:

FIG. 1 is a simplified schematic diagram illustrating a system for mixing slurry in accordance with the teachings of the present invention.

### DETAILED DESCRIPTION OF THE DRAWING

As used herein, “powder” means powders and other solids that are suitable for use in preparing a slurry, even though such solid may be in the form of lumps or pebbles or may be partially-hydrated. A “powder” may include, but is not limited to, lime, flyash, cement powder, or any combinations of the foregoing items. The term “scale” as used herein means an instrument, machine or other device for weighing an object. The term “feed pipe” as used herein includes, but is not limited to, pipes, tubes, hoses, sleeves and other means suitable for directing a flow of powder to an opening of a tank or for connection to another pipe.

In the following detailed description of the selected embodiments, reference is made to the accompanying drawing which forms a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

An embodiment of the present invention is described below primarily with reference to the preparation of a lime slurry. However, it should be noted that many other types of slurries may also be prepared using embodiments of the present invention such as, for example, cement, flyash, and gypsum slurries, or any combination of the foregoing items.

The present invention generally relates to a system and method for making a slurry by mixing a solid with water or another liquid. The formed slurry may be used, for example, in construction operations such as the preparation of soil at a work site prior to asphalt paving or in making buildings, bridges, and other structures.

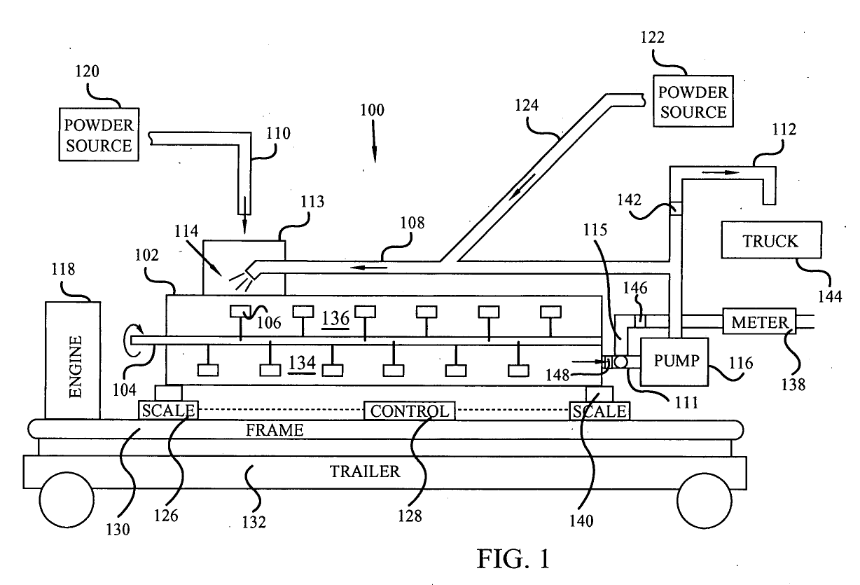

FIG. 1 is a simplified schematic diagram illustrating a system 100 for mixing slurry in accordance with the teachings of the present invention. System 100 includes tank 102 to contain a slurry during the mixing process and a recirculating pipe 108 coupled to recirculate at least a portion of the slurry from tank 102 by returning the portion as a recirculated slurry to tank 102. Feed pipe 110 or 124 is used to provide a powder to tank 102, and feed pipe 110 or 124 is generally positioned so as to feed the powder into the flow of the recirculated slurry.

The recirculated slurry and the powder first begin to mix at a physical position located at a vertical height above the top level of the slurry in tank 102 and typically above tank 102 itself. This is in contrast to prior mixing systems in which, for example, a powder and slurry are first mixed at a physical position that is vertically well below the physical boundary of the top of the main mixing tank body and often also is at a vertical height below the top level of the slurry in the mixing tank.

The recirculated slurry and the powder enter tank 102 while moving in a direction that is at least in part vertically downwards with respect to the main body of tank 102. In contrast, in prior systems the newly-mixed powder and liquid often enter the mixing tank through an inlet positioned towards the bottom half of the tank so that the incoming powder is below the top level of the slurry being mixed in the tank.

Feed pipe 124 may be connected to recirculating pipe 108 to provide a powder flow directly into the recirculated slurry, and feed pipe 124 may be used instead of, or in conjunction with, feed pipe 110. Powder source 122 may be used to provide the powder to feed pipe 124 and is, for example, a bulk lime trailer located near system 100. A flexible hose (not shown) may be connected between the bottom of the trailer and feed pipe 124. A conventional high-volume, low-pressure pump (not shown) may be used to blow air through a manifold at the bottom of the trailer's tank. As dry powder enters the stream of air, it is blown through the hose to feed pipe 124. When using only feed pipe 124, the powder and recirculated slurry first begin to mix together at a position located substantially at the connection of feed pipe 124 to recirculating pipe 108.

Feed pipe 110 may be positioned so that is it physically separate from recirculating pipe 108. Feed pipe 110 directs powder in a downward direction into the flow of recirculated slurry, which exits pipe 108 as stream 114. The outlet end of pipe 108 may be angled at a downward angle between about 20-90 degrees in order to direct the recirculated slurry into the main body of slurry being mixed in tank 102. This typically provides increased agitation of the slurry, which improves and speeds the overall mixing process. The powder may be blown or fall by gravity from powder source 120, which may be, for example, a portable auger-feed silo, through feed pipe 110 so that the powder contacts stream 114, which is typically rapidly moving. Powder source 120 may include an automatic shut-off valve (not shown) to connect to control system 128 to stop the powder feed as discussed below. The recirculated slurry and the powder are substantially first beginning to mix together as the recirculated slurry and the powder are moving in a direction that is generally vertically downwards towards the slurry contained in tank 102.

It should be noted that, for example, when preparing a lime slurry, the powder (if not pushed downward towards paddles 106) will have a tendency to form a dry bridge of material on the top surface of the slurry being mixed in tank 102, which reduces the effectiveness of the mixing process. By providing recirculating slurry in a downwards direction into tank 102 as described herein, powder resting or crusting on the top surface may be broken up by the downward stream and may be pushed downward towards the middle of tank 102 so that mixing is improved.

The recirculated slurry and powder enter tank 102 through an opening provided, for example, by an inlet enclosure 113 positioned above an upper region 136 of tank 102. The opening may be positioned, for example as shown in FIG. 1, above a shaft 104, which may be used to rotate paddles 106 (discussed in more detail below) for mixing the slurry. Recirculating pipe 108 may release recirculated slurry substantially within inlet enclosure 113. Inlet enclosure 113 is typically open on its top to the atmosphere so that powder from feed pipe 110 may enter and so that excess air, steam and any other gaseous reaction products from the slurry mixing process may escape. However, in other embodiments, inlet enclosure 113 may be fully enclosed, and other means of air and gas escape provided. The powder and slurry flow typically substantially downwards from inlet enclosure 113 into slurry in a lower region 134 of tank 102. It should be noted that when using either feed pipe 110 or 124 the fresh powder first substantially enters the slurry contained within the tank by entering through the top surface of the slurry. The top surface may be located in upper region 136 or lower region 134, and the slurry usually does not fully fill tank 102. Typically, the powder and recirculated slurry have mixed to some extent prior to entering through such top surface. The entry of the recirculated slurry through such top surface, especially when assisted by the downward-angled outlet end of pipe 108, provides agitation according to the present invention that assists in the slurry mixing process.

System 100 may include pump 116 coupled to move the recirculated slurry from tank 102 through recirculating pipe 108. A delivery pipe 112 may be coupled to receive slurry from pump 116 for delivery to a vehicle such as, for example, slurry spreader truck 144, or other slurry distribution system. A valve 142 is normally closed during slurry mixing, but opened for delivery of the prepared slurry.

Outlet pipe 111 may be used to remove slurry from lower region 134 of tank 102. It should be noted that in this embodiment outlet pipe 111 removes slurry from tank 102 at an opposite end of tank 102 in which recirculated slurry enters tank 102. A liquid feed source 115 for providing, for example, water or another liquid may connect to outlet pipe 111 so that incoming fresh liquid may be provided to the inlet of pump 116. Flow meter 138 may be used to measure the volume or weight of liquid provided to system 100. Valve 148 may be closed when the liquid feed is initially started and then opened later as tank 102 fills with slurry. Valve 146 may be closed after all desired liquid has been added.

An engine 118 such as, for example, a diesel engine may be used to provide hydraulic, electrical and/or mechanical power for operating pump 116, control system 128, scales 126 and other components of system 100. Tank 102 may include paddles 106 for stirring slurry during preparation. Paddles 106 may be attached to shaft 104, which may be rotated using hydraulic power, for example, obtained from engine 118. Other means of stirring or mixing the slurry may be used instead of, or even in addition, to paddles 106.

System 100 further may include frame 130 on which tank 102, pump 116, recirculating pipe 108 and most or all other components of system 100 are supported for transportation from one jobsite to another on a trailer 132. Feed pipes 110 or 124 may be configured for ready disconnection from system 100 for transportation of frame 130. Frame 130 may optionally be removable from trailer 132 for placement on the ground or another suitable support when located at a jobsite. Control for the mixing process may be provided through electrical sensors and speed controls, solenoid valves and instrumentation (not shown), which may be operated from an electrical system (for example, a 12-volt system) of engine 118.

Operation of system 100 may typically require only a source of water and a powder delivery truck to begin production. On larger jobs, a powder and or liquid storage tank or trailer (not shown) may be located at the site to allow for ease of production. The unit may be used economically on small jobs where prior methods are difficult to justify due to higher set-up costs. In accordance with one embodiment, the slurry mixing system may be transported to or near a jobsite. Calcium oxide may be delivered to the slurry mixing system in dry powder or pebble form, often from a bulk road tanker (not shown). The calcium oxide may be discharged from the bulk road tanker, for example, by blowing the dry powder or pebbles as described above through feed pipe 124.

Tank 102 typically may have a capacity of more than about 1,000 gallons, and more specifically, may have a capacity, for example, of about 6,000 to 10,000 gallons. A typical commercially-available slurry spreader truck may have a capacity to hold, for example, about 4,000 to 5,000 gallons of slurry. Additional details regarding systems and methods for constructing and operating slurry mixing systems are described by Teague et al. (U.S. Pat. No. 4,329,090), Scholl et al. (U.S. Pat. No. 6,412,974), and Shields et al. (U.S. Pat. No. 5,507,572), which patents were incorporated by reference above.

The initial water or other liquid used to prepare the slurry may be provided into outlet pipe 111 as indicated in FIG. 1 and pumped using pump 116 back into tank 102 via recirculating pipe 108. In one approach, initially only fresh feed liquid is pumped back into tank 102 (e.g., where no powder has yet been added to system 100). Later in the mixing process, when sufficient water has been added for the desired final mixture, fresh liquid feed source 115 may be turned off and pump 116 continue to recirculate the slurry mixture through pipe 108 as the slurry is being prepared.

Slurry Mixing Process

Now more specifically discussing lime slaking, a slaking or lime hydrating system is used to provide a hydration process for liming compounds. Slaking is complex due to the highly exothermic nature of the CaO hydration reaction, and the multitude of variables that may affect the final properties of the slaked lime. Controlling variables such as temperature is desirable. Temperature-control equipment and a means for venting off some of the heat of hydration is also desirable, as well as a means to control lime dust. Generally, it is desirable to control the temperature below boiling and above 180° F. (82° C.).

When making a lime slurry, the lime used may be quicklime, hydrated lime or other raw material sources such as lime kiln dust. In many cases, the use of quicklime may be preferable because of the heat generated during slaking and the ease with which the lumps or pellets of quicklime can be unloaded and delivered to tank 102. In forming lime slurries, the water used may vary in quality. Conventional water sources may include city water mains, wells, railroad storage facilities, highway department storage facilities, lakes, streams, and other similar sources. As a specific example, the amount of lime solids added to tank 102 may range between 20-45% by weight to that of the total lime slurry. For example, 4,000 gallons of water may be used to fill tank 102 to a pre-selected level. To this may be added, for example, 16,600 lbs. of lime. High calcium lime is usually preferable for most applications, although dolomitic lime can be used. The lime may have impurities, but will often be better than 90% CaO or Ca(OH)₂, depending on the type of lime used.

Weighing of Tank During Mixing of Slurry

According to another aspect of the present invention, which may optionally be used with system 100, a system and method are provided for mixing a slurry by measuring the weight of tank 102 during at least certain portions of the slurry mixing process. A system and method for preparing a slurry using system 100 is now described below.

System 100 may include one or more scales 126 that support tank 102 so that the weight of materials added to the tank during mixing of the slurry can be measured. Such materials include, for example, powder and liquid used to form a slurry mixture. In addition, other materials to be added may be weighed using the system of the present invention.

According to this aspect of the invention, scales 126 are preferably used at all or substantially all points of primary mechanical support 140 for tank 102 so that the quantity of lime and/or water added may be weighed to obtain the proper final desired proportions. For example, each point of primary mechanical support 140 may be connected to at least one scale 126. Preferably, tank 102 is supported by three or more supports 140. Even more preferably, four or more supports 140 are used. However, in other embodiments, it is not required that there be a separate scale 126 for each support 140. The form of mechanical structure of support 140 is not critical and many variations may be used.

Scales 126 may be, for example, beam scales or other types of scales suitable for measuring industrial weight loads of, for example, greater than about 1,000 pounds. Scales 126 should be selected to be able to withstand the load, vibration and temperature of operation seen at jobsites. Scales 126 are connected for control by conventional control system 128, which may provide weight information as determined from one or more of scales 126. This weight information may be presented on a user display (not shown) for manual reading by an operator. Also, the weight information may be provided as an electronic control signal, which may be used, for example, for further command or control functions. The control signal may be used, for example, to terminate the providing of a liquid from liquid feed source 115 (e.g., using a control valve as valve 146), or to terminate the providing of powder from powder source 120.

One of skill in the art will recognize that certain hoses and other elements may be connected to tank 102 and also to another portion of system 100 other than solely through supports 140. These other connections do not substantially affect the practice of the invention. Also, one of skill in the art may make adjustments to the weight measurements of tank 102 as appropriate to account for these other connections. Further, the mechanical means used to rotate shaft 104, pump 116, and to power other components of system 100 are preferably attached to tank 102 in some manner (e.g., a support mounted to the external portion of tank 102) so that the weighing of tank 102 is not adversely affected by direct contact of such components to frame 130 (or otherwise) except through supports 140 and scales 126.

The liquid feed may be measured using flow meter 138 to provide the proper quantity of liquid, and scales 126 may be used to measure the mass of powder or liquid added to tank 102. Control system 128 may be connected to scales 126 and may be used to automatically shut off the powder source and/or the liquid feed source using conventional control and delivery components.

More specifically, according to a first method of mixing a slurry, a quantity of liquid is added to tank 102. The desired amount of liquid to be added is determined by measuring the weight of tank 102 as the liquid is added. This weighing may be done using scales 126 and control system 128. In other embodiments, it may be possible that other means of weighing tank 102 are used. In this first method, the desired amount of liquid is first added. Pump 116 may be used to pull liquid from liquid feed source 115 for pumping into tank 102 through recirculating pipe 108. After the liquid has been added, then powder may be added into tank 102 as described above. The weight of tank 102 is again measured to determine when the desired amount of powder has been added.

According to a second method of mixing a slurry, a quantity of liquid is added to tank 102, but the quantity is determined by metering the amount of the liquid as it is added to tank 102. This metering may be done, for example, using flow meter 138 to measure the volume or weight of the liquid. Powder is added to tank 102 as described above, and the weight of tank 102 is measured to determine the amount of powder added. The liquid may be added while the powder is also being added in order to reduce the total mixing time. The quantity of liquid added may be used to determine appropriate weight adjustments or calculations to make as tank 102 is measured to determine the quantity of powder being added. Scales 126 may be used to weigh tank 102, and control system 128 may include software and a computer (not shown) to perform such compensating calculations.

Note that valve 148 may be closed initially so that fresh liquid is contacting incoming powder. Later, valve 148 may be opened to begin the contacting of fresh powder with recirculated slurry.

### CONCLUSION

By the foregoing description, a novel system and method for mixing a slurry have been described. In contrast to prior mixing systems, the system and method of the present invention may be used to make smaller loads (for example, that do not necessarily require that an entire truck load of solid lime be mixed at once), and in which such a smaller load may often be mixed faster than with prior slurry mixing systems. This may allow the faster loading of a fully-mixed slurry into a first truck, and then allow the faster loading of additional slurry loads into subsequent trucks. The system and method of the present invention may also reduce or eliminate the need for using multiple mixing tanks at a jobsite.

Although specific embodiments have been described above, it will be appreciated that numerous modifications and substitutions of the invention may be made. For example, system 100 may also be used for preparing other slurries made from a powder and liquid mixture such as, for example, cement slurries made from cement powder and water. Accordingly, the invention has been described by way of illustration rather than limitation.

What is claimed is:

1. A system for mixing slurry comprising:
a tank to contain a slurry during mixing;
a recirculating pipe coupled to recirculate at least some of the slurry from the tank by returning a recirculated slurry to the tank;
a feed pipe to provide a powder to the tank wherein the feed pipe is positioned to feed the powder into the recirculated slurry; and
wherein:
the recirculated slurry and the powder first begin to mix at a position located above the tank; and
the recirculated slurry and powder enter the tank while moving in a direction that is at least in part downwards.

2. The system of claim 1 wherein the feed pipe is connected to the recirculating pipe.

3. The system of claim 2 wherein the recirculated slurry and the powder first begin to mix together at a position located near the connection of the feed pipe to the recirculating pipe.

4. The system of claim 1 wherein the feed pipe is separate from the recirculating pipe.

5. The system of claim 1 wherein an outlet end of the recirculating pipe is angled downwards to direct the recirculated slurry into the tank for increased agitation of the slurry as it is mixed in the tank.

6. The system of claim 5 wherein the outlet end is angled at a downward angle between about 20 degrees to 90 degrees.

7. The system of claim 1 wherein the recirculated slurry and the powder are mixing together as the recirculated slurry and the powder are moving in a direction at least partially downwards towards the tank.

8. The system of claim 1 wherein the recirculated slurry and the powder enter the tank through an opening of the tank positioned above a lower region of the tank.

9. The system of claim 1 wherein the recirculated slurry enters the tank while moving primarily in a downwards direction.

10. The system of claim 1 further comprising an inlet enclosure on the tank wherein the recirculating pipe has an outlet positioned to release the recirculated slurry within or below the inlet enclosure.

11. The system of claim 10 wherein the inlet enclosure comprises an opening to the outside atmosphere.

12. The system of claim 11 wherein the powder is introduced into the inlet enclosure through the opening.

13. The system of claim 11 wherein:
the inlet enclosure is positioned substantially over an upper region of the tank; and
the powder and the recirculating slurry move into the tank by flowing substantially downwards from the inlet enclosure towards a lower region of the tank.

14. The system of claim 1 further comprising a plurality of members attached to a shaft operable to rotate to promote mixing of the slurry in the tank; and wherein the recirculated slurry and the powder enter the tank through an opening positioned above the shaft.

15. The system of claim 14 wherein the members are paddles.

16. The system of claim 14 further comprising:
a pump coupled to move the recirculated slurry from the tank through the recirculating pipe; and
a delivery pipe coupled to receive slurry from the pump for delivery to a vehicle or other slurry distribution system.

17. The system of claim 16 further comprising:
a frame wherein the tank, pump, and recirculating pipe are supported by the frame for transportation of the system from one jobsite to another jobsite.

18. The system of claim 17 wherein:
the feed pipe is operable to be disconnected from the recirculating pipe for transportation of the system; and
the frame is supported on a trailer.

19. The system of claim 1 wherein the powder comprises lime or cement.

20. The system of claim 1 further comprising:
a pump coupled to move the recirculated slurry from the tank through the recirculating pipe; and
a liquid feed source coupled to provide a liquid to an inlet of the pump.

21. The system of claim 20 wherein the liquid is water.

22. The system of claim 1 wherein the tank has a capacity of more than about 1,000 gallons.

23. A system for mixing slurry comprising:
a tank to contain a slurry during mixing, wherein the slurry within the tank has a top surface;
a recirculating pipe coupled to recirculate at least some of the slurry from the tank by returning a recirculated slurry to the tank;
a feed pipe to provide a powder to the tank wherein the feed pipe is positioned to feed the powder into the recirculated slurry; and
wherein the system is configured so that the powder first substantially enters the slurry contained within the tank through the top surface of the slurry.

24. The system of claim 23 wherein the slurry does not completely fill the tank.

25. The system of claim 23 wherein the powder is partially mixed with the recirculated slurry prior to entering the slurry in the tank.

26. The system of claim 23 wherein the recirculated slurry is directed in a downward direction for entry into the top surface of the slurry.

27. The system of claim 23 wherein the powder and recirculated slurry begin to mix prior to entering the tank.

28. The system of claim 23 wherein the powder and recirculated slurry begin to mix after entering the tank.

29. The system of claim 23 further comprising a plurality of paddles located within the tank for mixing the slurry.

30. A system for mixing slurry comprising:
a tank to contain a slurry during mixing;
a recirculating pipe coupled to recirculate at least some of the slurry from the tank by returning a recirculated slurry to the tank;
a feed pipe to provide a powder to the tank wherein the feed pipe is positioned to feed the powder into the recirculated slurry;
an inlet enclosure connected to an upper portion of the tank; and
wherein:
the recirculating pipe enters the inlet enclosure and has an outlet positioned to release the recirculated slurry into the tank; and
the powder moves into the tank by flowing downwards from the region of the inlet enclosure into the tank.

31. The system of claim 30 wherein the inlet enclosure has an opening to the outside atmosphere and is connected to the top of the tank.

32. The system of claim 30 wherein an outlet of the feed pipe is directed in a direction downwards below the opening of the inlet enclosure.

33. A system for mixing slurry comprising:
a tank to contain a slurry during mixing; and
one or more scales supporting the tank so that the weight of one or more materials added to the tank during mixing of the slurry can be measured.

34. The system of claim 33 wherein the tank has a capacity of more than about 1,000 gallons.

35. The system of claim 33 wherein each point of primary mechanical support for the tank is connected to at least one scale.

36. The system of claim 35 wherein the tank is primarily supported by three or more supports and each of the supports is connected for weighing by a scale.

37. The system of claim 35 wherein the scale is a beam scale.

38. The system of claim 33 further comprising a control system, coupled to the one or more scales, operable to provide weight information determined by the one or more scales.

39. The system of claim 38 wherein the weight information is provided on a user display for manual reading or is provided as an electronic signal.

40. The system of claim 38 further comprising:
a powder source coupled to provide a powder to the tank; and
a liquid feed source coupled to provide a liquid to the tank.

41. The system of claim 40 wherein the control system is operable to provide a control signal used to do one or more of the following: (a) terminate the providing of liquid from the liquid feed source, or (b) terminate the providing of powder from the powder source.

42. The system of claim 40 further comprising a flow meter coupled to measure the amount of the liquid provided to the tank.

43. A method of mixing slurry in a tank, comprising:
adding a liquid to the tank;
measuring the weight of the tank to determine the amount of liquid added to the tank; and
adding powder to the tank.

44. The method of claim 43 further comprising measuring the weight of the tank to determine the amount of powder added to the tank.

45. The method of claim 44 wherein the step of measuring the weight of the tank to determine the amount of powder is performed after substantially completing the step of adding the liquid to the tank.

46. The method of claim 43 wherein the tank has a capacity of more than about 1,000 gallons.

47. The method of claim 43 wherein the step of measuring the weight of the tank comprises using one or more scales mechanically coupled to the tank.

48. The method of claim 43 further comprising recirculating the slurry back into the tank.

49. The method of claim 48 wherein the step of recirculating the slurry comprises using a recirculating pipe coupled to recirculate at least some of the slurry from the tank by returning a recirculated slurry for entry into the top of the tank; and the method of claim 48 further comprising providing a feed pipe to provide the powder to the tank wherein the feed pipe is positioned to feed the powder into the recirculated slurry.

50. A method of mixing slurry in a tank, comprising:
adding a liquid to the tank;
metering the amount of the liquid as it is added to the tank;
adding powder to the tank; and
measuring the weight of the tank to determine the amount of powder added to the tank.

51. The method of claim 50 wherein the steps of adding the liquid and adding the powder are each performed, at least for a portion of the duration of each step, at the same time.

52. The method of claim 50 wherein the tank has a capacity of more than about 1,000 gallons.

53. The method of claim 50 wherein the step of measuring the weight of the tank comprises using one or more scales mechanically coupled to the tank.

54. The method of claim 50 wherein the step of metering the amount of the liquid comprises measuring the volume of the liquid.

55. The method of claim 50 further comprising recirculating the slurry back into the tank.

56. The method of claim 55 wherein the step of recirculating the slurry comprises using a recirculating pipe coupled to recirculate at least some of the slurry from the tank by returning a recirculated slurry for entry into the top of the tank; and the method of claim 55 further comprising providing a feed pipe to provide the powder to the tank wherein the feed pipe is positioned to feed the powder into the recirculated slurry.
